(19) United States
(12) Patent Application Publication
(10) Pub. No.: US 2004/0054050 A1
(43) Pub. Date: Mar. 18, 2004

(54) Compositions based on polyvinylidene fluoride

(75) Inventors: Thierry Pascal, Charly (FR); Bruno Schlund, Chaponost (FR)

Correspondence Address: MILLEN, WHITE, ZELANO & BRANIGAN, P.C., 2200 CLARENDON BLVD., SUITE 1400, ARLINGTON, VA, 22201, US

(73) Assignee: ATOFINA, Puteaux (FR)

(21) Appl. No.: 10/382,982

(22) Filed: Mar. 7, 2003

(30) Foreign Application Priority Data
Mar. 7, 2002 (FR) 02.02876

(51) Int. Cl. C08K 5/09; C08L 27/12

(52) U.S. Cl. 524/306; 525/199

(57) ABSTRACT

The present invention relates to a flexible and tough composition comprising:

at least one vinylidene fluoride (VF2) homopolymer (A) or a copolymer (A) of VF2 and at least one other monomer copolymerizable with VF2, in which the said monomer is present in an amount of between 0 and 30 parts by weight per 100 parts by weight of VF2,

at least one fluoroelastomer B,

optionally a plasticizer C,

in which, on the one hand, the said composition comprises from 0.5 to 10 parts by weight of B and from 0 to 10 parts by weight of C per 100 parts by weight of A, with the additional condition that the sum of B and C is from 0.5 to 10.5 parts by weight and, on the other hand, the vinylidene fluoride homopolymer or copolymer (A) is chosen in such a way that it has a melt flow index, measured according to the ISO 1133 standard at 230° C. under a load of 5 kg, of less than 5 g/10 min and a critical modulus G_{C}, at the intersection of the melt shear moduli G′ and G″ measured at 190° C., of between 5 and 22 kPa.

This composition is especially used for the manufacture of pipes for conveying hydrocarbons extracted from off-shore or on-shore oil deposits.

### FIELD OF THE INVENTION

The present invention relates to the polymer field and the subject thereof is compositions based on polyvinylidene fluoride.

Fluorohomopolymers and fluorocopolymers are known for their good thermal withstand capability, their chemical resistance, especially to solvents, weatherability and resistance to radiation (UV, etc.), their impermeability to gases and to liquids, and their property of being electrical insulants. They are used in particular for the production of pipes for conveying hydrocarbons extracted from off-shore or on-shore oil deposits. The hydrocarbons are sometimes transported at high temperatures (of about 135° C.) and at a high pressure (for example 70 MPa). Severe problems therefore arise, during operation of installations, relating to the mechanical, thermal and chemical resistance of the materials employed. Other requirements are added to them before or after service: thus, during their production, their laying and/or their removal (reeling/unreeling), the pipes may be subjected to flexural loads and -impacts which they must also withstand and, sometimes, they must do so at particularly low temperatures (for example −35° C.).

### PRIOR ART AND THE TECHNICAL PROBLEM

In order to try to meet these short-term and long-term requirements, various types of materials have been proposed, generally comprising one or more metallic components which guarantee mechanical rigidity, for example a spiralled steel tape, as -well as various layers based on polymeric compositions, which in particular provide impermeability and thermal insulation. These compositions, often based on semicrystalline fluoropolymers, especially on poly(vinylidene fluoride) (PVDF), are often plasticized in order to remedy a lack of flexibility, a low deformation at the yield point and an insufficient toughness, this having the drawback of the plasticizers being extracted relatively rapidly by the hydrocarbons transported, gradually resulting in a loss of the properties provided by the plasticization (flexibility, toughness, etc.), being accompanied in general by shrinkage phenomena and consequently limiting the lifetime of the articles based on these compositions.

In order to solve some of these problems, the optionally plasticized fluoropolymers have been replaced by polymeric compositions comprising a PVDF homopolymer, a thermoplastic copolymer (and not an elastomer) of vinylidene fluoride (VF2) and of at least one other fluoromonomer (EP 608 939 and EP 608 940) and a plasticizer (EP 608,939). However, strict and precise control of the morphology of such blends demands the use of complex and expensive apparatus which therefore makes this technical solution not easily realizable; moreover, it is found that these blends have a limited toughness at low temperature and a poor swelling resistance, for example when in contact with hydrocarbons, and a chemical withstand capability which is inferior to that of PVDF alone, and any plasticizer is extracted when in contact with certain chemicals. In addition, the PVDF homopolymer represents only 60 to 80% by weight of the composition in Patent EP 608 039 and 25 to 75% in Patent EP 608 940.

Elastomeric particles have also been incorporated into PVDF (FR 2 592 655 and FR 2 618 791) for the purpose of absorbing the liquid hydrocarbons and of fixing them throughout the blend, the proportion of elastomer within the blend having not to exceed 25% of the total mass. Such blends have improved toughness over PVDF alone, but their flexibility is insufficient for certain applications envisaged, especially for the transportation and/or storage of gaseous hydrocarbons, as this type of blend is not very flexible when not in direct contact with the liquid hydrocarbons. FR 2 592 655 has described blends containing, in addition, at least 10% by weight of plasticizer, which, although they possess both the desired flexibility and the desired impact strength, sooner or later let the plasticizer exude.

Patent Application EP 0 714 944 describes compositions comprising a PVDF matrix in which nodules of vulcanized elastomers optionally flexibilized by plasticizers are dispersed. The multiaxial impact strength of these compositions is very good, but the amount of,elastomers, 26.6 or 50 parts by weight per 100 parts by weight of PVDF 1 000 (Examples 6 and 11), is so high that these compositions lack thermal and chemical stability at 150° C. In addition, these compositions have the drawback of a high permeability under pressure and a poor resistance to the rapid decompression of hot pressurized gases (“blistering”).

Patent WO 98/56855 proposed to solve the abovementioned technical problems and the subject thereof is a flexible and tough composition comprising:

at least one homopolymer (A) of vinylidene fluoride (VF2) or a copolymer (A) of VF2 and of at least one other monomer copolymerizable with VF2, in which the said monomer is present in an amount of between 0 and 30 parts by weight per 100 parts by weight of VF2,

at least one elastomer B,

at least one plasticizer C,

characterized in that, on the one hand, the said composition comprises from 0.5 to 10 parts by weight of B and from 0.5 to 10 parts by weight of C per 100 parts by weight of A, with the additional condition that the sum of B and C is from 1 to 10.5 parts by weight and, on the other hand, in that the vinylidene fluoride homopolymer or copolymer A is chosen in such a way that it has a melt flow index, measured according to the ISO 1133 standard at 230° C. under a load of 5 kg, of less than 5 g/10 min and a critical modulus G_{C}, at the intersection of the melt shear moduli G′ and G″ measured at 190° C., of between 5 and 22 kPa, the said composition having the following properties:

an elongation at the yield point, ε_{y}, of greater than 11%, an elongation at break ε_{b} of greater than 200%, an impact strength at 23° C. of greater than 50 kJ/m² and an impact strength at −30° C. of greater than 10 kJ/m², these being measured according to the ISO 180-1982 standard, a resistance to flexural rupture on a sleeved metal tape of greater than 50%, a weight loss Aw in air at 150° C. for 1 month of less than or equal to 8% and a weight change Aw in petroleum (equal-volume mixture of cyclohexane, isooctane and xylene) at 150° C. for 1 month which is not negative (the said composition does not lose weight in petroleum).

The critical modulus G_{C} is determined at 190° C. using a dynamic mechanical spectrometer, for example of the Rheometrics RMS 800 type, using a 25 mm diameter plane-plane viscometer.

In this Patent WO 98/56855, the elastomer B is either based on a polyacrylic core-shell structure or based on a polysiloxane structure or else an NBR (nitrile butadiene rubber) and, in addition, it is also necessary to use a plasticizer. It has just been discovered that if the elastomer B is a fluoroelastomer, the presence of the plasticizer is not strictly necessary for obtaining the required mechanical properties and, in addition, the stability in air and in petroleum are markedly improved.

### BRIEF DESCRIPTION OF THE INVENTION

The present invention relates to a flexible and tough composition 1 5 comprising:

at least one vinylidene fluoride (VF2) homopolymer (A) or a copolymer (A) of VF2 and at least one other monomer copolymerizable with VF2, in which the said monomer is present in an amount of between 0 and 30 parts by weight per 100 parts by weight of VF2,

at least one fluoroelastomer B,

optionally a plasticizer C,

in which, on the one hand, the said composition comprises from 0.5 to 10 parts by weight of B and from 0 to 10 parts by weight of C per 100 parts by weight of A, with the additional condition that the sum of B and C is from 0.5 to 10.5 parts by weight and, on the other hand, the vinylidene fluoride homopolymer or copolymer (A) is chosen in such a way that it has a melt flow index, measured according to the ISO 1133 standard at 230° C. under a load of 5 kg, of less than 5 g/10 min and a critical modulus G_{C}, at the intersection of the melt shear moduli G′ and G″ measured at 190° C., of between 5 and 22 kPa.

This composition has the following properties:

an elongation at the yield point ε_{y} of greater than 9%, an elongation at break ε_{b} of greater than 200%, an impact strength at 23° C. of greater than 46 kJ/m² and an impact strength at −30° C. of greater than 10 kJ/m², these being measured according to the ISO 180-1982 standard, a resistance to flexural rupture on a sleeved metal tape of greater than 50%, a weight loss Δw in air at 150° C. for 1 month of less than or equal to 8% and a weight change Δw in petroleum (equal-volume mixture of cyclohexane, isooctane and xylene) at 150° C. for 1 month which is not negative (the said composition does not lose weight in petroleum).

After a residence time in air at 150° C. of 1 month, the elongation at break ε_{b} decreased by less than 10%, whereas in the case of the compositions in which the elastomer B is not a fluoroelastomer the decrease is from 12 to 25%.

After a residence time in air at 150° C. for 12 months, the elongation at break ε_{b} decreased by 0 to 20%, whereas in the case of the. compositions in which the elastomer B is not a fluoroelastomer the decrease is about 50%.

After a residence time in petroleum at 150° C. of 1 month, the elongation at break ε_{b} either increased or remained constant, whereas in the case of the compositions in which the elastomer B is not a fluoroelastomer the decrease is from 15 to 25%.

The critical modulus G_{C} is determined at 190° C. using a dynamic mechanical spectrometer, for example of the Rheometrics RMS 800 type, using a 25 mm diameter plane-plane viscometer.

Preferably, the said other monomer in polymer A is present in a relative amount of between 0 and 5 parts by weight.

Preferably, the said other monomer is a fluoromonomer.

Advantageously, B is present in a relative amount of 0.5 to 5 parts by weight per 100 parts by weight of A.

Advantageously, C is present in a relative amount of 0.5 to 5 parts by weight per 100 parts by weight of A.

The fluoropolymers A of the compositions according to the invention are chosen from VF2 homopolymers or copolymers because of their excellent chemical inertness in the presence of crude gas or petroleum and because of their high-temperature stability.

Preferably, the compositions according to the invention comprise 100 parts by weight of vinylidene fluoride homopolymer, 2.1 parts by weight of B and 3.2 parts by weight of C, the homopolymer being chosen so as to have an MFI, measured at 230° C., of 0.7 and a critical modulus G_{C}, measured at 190° C., of 20 kPa.

### DETAILED DESCRIPTION OF THE INVENTION

The fluoroelastomers B that can be used within the context of the invention may be chosen from true elastomers or polymer resins serving as a base constituent for obtaining true elastomers.

True elastomers are defined by the ASTM, Special Technical Bulletin, No. 184 standard as materials capable of being stretched, at room temperature, to twice their intrinsic length and which, once they have been released after holding them under tension for 5 minutes, return to within 10% of their initial length in the same time.

Polymer resins serving as a base constituent for obtaining true elastomers are in general amorphous products or products having a low degree of crystallinity (crystalline phase less than 20% by volume) having a glass transition temperature (T_{g}) below room temperature. In most cases, these products correspond to copolymers or terpolymers having a T_{g} below 0° C. and able to include reactive functional groups (optionally in the presence of additives) allowing the true elastomer to be formed.

The fluoropolymers B are advantageously copolymers of VF2 and at least one other fluoromonomer. As examples of comonomers, mention may be made of vinyl fluoride; trifluoroethylene; chlorotrifluoroethylene (CTFE); 1,2-difluoroethylene; tetrafluoroethylene (TFE); hexafluoropropylene (HFP); perfluoro(alkyl vinyl) ethers, such as perfluoro(methyl vinyl) ether (PMVE), perfluoro(ethyl vinyl) ether (PEVE) and perfluoro(propyl vinyl) ether (PPVE); perfluoro(1,3-dioxole); perfluoro(2,2-dimethyl-1,3-dioxole) (PDD); the product of formula CF₂═CFOCF₂CF(CF₃)OCF₂CF₂X in which X is SO₂F, CO₂H, CH₂OH, CH₂OCN or CH₂OPO₃H; the product of formula CF₂═CFOCF₂CF₂SO₂F; the product of formula F(CF₂)ₙCH₂OCF═CF₂ in which n is 1, 2, 3, 4 or 5; the product of formula R₁CH₂OCF═CF₂ in which R₁ is hydrogen or F(CF₂), and z is 1, 2, 3 or 4; the product of formula R₃OCF═CH₂ in which R₃ is F(CF₂)_{z}— and z is 1, 2, 3 or 4; perfluorobutylethylene (PFBE) ; 3,3,3-trifluoropropene and 2-trifluoromethyl-3,3,3-trifluoro-1-propene. Several comonomers may be used.

As examples of elastomer B, mention may be made of VF2/HFP copolymers in which the proportions by weight of VF2 are between 50 and 75% for 50 to 25% HFP respectively. Mention may also be made of VF2/HFP/TFE copolymers containing 45 to 65% VF2, the proportions of HFP and TFE being such that the HFP/TFE weight ratio is between 1/5 and 5/1 and preferably 1/2 and 2/1.

These elastomers B may be manufactured by the process described in “Composition and sequence distribution of vinylidene fluoride copolymer and terpolymer fluoroelastomers. Determination by 19F nuclear magnetic resonance spectroscopy and correlation with some properties.” By Maurizio Pianca, Piergiorgio Bonardelli, Marco Tato, Gianna Cirillo and Giovanni Moggi. POLYMER, 1987, Vol. 28, February, 224-230.

The plasticizers C may be chosen from the usual plasticizers and especially those described in U.S. Pat. No. 3,541,039 and U.S. Pat. No. 4,584,215. Preferably, the plasticizer is chosen from dibutyl sebacate and N-n-butylsulphonamide.

Apart from the constituents A, B and C described above, the compositions according to the invention may contain various organic or inorganic, macromolecular or non-macromolecular additives and/or fillers and/or colorants and/or pigments well known in the literature.

By way of non-limiting examples of fillers, mention may be made of mica, alumina, talc, carbon black, glass fibres, carbon fibres and macromolecular compounds.

By way of non-limiting examples of additives, mention may be made of UV stabilizers, fire retardants, heat stabilizers and processing aids.

The sum of these various additives and fillers generally represents less than 20% of the total mass A+B+C.

Advantageously, the preparation of the compositions according to the invention is carried out by melt blending the components A, B and C.

The composition according to the invention may be prepared by melt blending the vinylidene homopolymer or copolymer A with the elastomer or elastomers B—initially in the form of powders or granules—in an extruder, a two roll mill or any type of suitable mixing apparatus.

It is also possible to blend a latex of a vinylidene homopolymer or copolymer with the elastomer or elastomers in powder or latex form.

The plasticizer or plasticizers together with the optional additives may be incorporated into the compositions during the blending of A and B, or may be blended with one or other of these constituents prior to the step of blending A and B, or after blending A and B using the mixing techniques mentioned above.

The compositions according to the invention may be used for producing materials exposed to stresses under high-temperature and/or low-temperature conditions, in contact with particularly aggressive substances (such as hydrocarbons, strong acids, solvents, inorganic and organic bases) during which their toughness and flexibility properties are particularly required.

As indicated above, the compositions according to the invention are particularly suitable for manufacturing the impermeable sleeves of flexible metal pipes for the extraction and/or transportation of gases and hydrocarbons in the oil and gas industries.

These impermeable sleeves are generally in the form of monolayer or multilayer tubes, manufactured by extrusion or coextrusion, into which the flexible metal pipe is then inserted, or else they are formed directly around the flexible pipe using the standard overjacketing techniques.

The composition according to the invention may be used in multilayer impermeable sleeves such as those described, for example, in U.S. Pat. No. 5,601,893.

The compositions according to the invention are also well suited for producing, by extrusion, chemical engineering components, especially in the form of pipes and tubes, and for producing objects in the civil engineering and building industries, such as cable sheaths, stays, and monolayer or multilayer films and sheets for any kind of industry.

The composition according to the invention may also be used in sleeves of wires, ropes, cables and stays, such as those described in Patent Applications EP 671 502 and EP 671 746.

### EXAMPLES

One of the elastomers B1, B2, B5 to B7 and the plasticizer C1 were extruded using a single-screw extruder having a diameter of 40 mm (L/D=33; compression ratio=3.5) regulated to 220° C., compositions (Ai Bj Ck x) containing at least one of the fluoropolymers A4, A5 or A7. Depending on the respective proportions of the various constituents, the compositions are referred to as α, X, φ, η and γ.

Table 1 gives the melt flow index of the fluoropolymers Ai which are VF2 homopolymers or a VF2 copolymer as well as their critical modulus G_{C}; the melt flow index MFI was measured according to the ISO 1133 standard at 230° C. under a load of 5 kg and the critical modulus G_{C} was determined at 190° C. by means of a dynamic mechanical spectrometer, for example of the Rheometrics RMS 800 type, using a 25 mm diameter plane-plane viscometer.

Table 2 gives the chemical nature, trade name and suppliers of the elastomers Bj.

Table 3 gives the chemical nature and the family to which the plasticizers Ck belong; Table 4 gives the proportions by weight of the constituents of the compositions illustrated and the reference symbol of the corresponding compositions.

TABLE 1

| | | | VF2 copolymer |
|---|---|---|---|
| Nature of the | VF2 | VF2 | containing 1% by |
| polymer | homopolymer | homopolymer | weight of C₂F₃Cl |
| No. of fluoro- | A4 | A5 | A7 |
| polymer | | | |
| MFI | 0.7 | 0.14 | 0.8 |
| (g/10 min) | | | |
| G_{C} | 20 | 11 | 21 |
| (kPa) | | | |

The VF2 homopolymers or copolymers were prepared by the conventional emulsion or suspension radical polymerization processes as described in Patent Applications EP 709 429, FR 2 286 153 and FR 2 610 325. They may also be prepared by solution or bulk polymerization.

TABLE 2

| Elastomer | Nature of the | | |
|---|---|---|---|
| No. | elastomer | Trade name | Supplier |
| B1 | Acrylic elastomer | Durastrength ® | Ceca (France) |
| | | 200 | |
| B2 | Acrylic elastomer | Paraloid ® E 653 | Röhm & Haas |
| B5 | 60/40 VF2/C₃F₆ | | |
| | copolymer | | |
| B6 | 70/30 VF2/C₃F₆ | | |
| | copolymer | | |
| B7 | 48/30/22 | | |
| | VF2/C₃F₆/C₂F₄ | | |
| | copolymer | | |

More specifically, the elastomer B1 is a core-shell polymer with an acrylic shell and is prepared by radical polymerization in aqueous phase of acrylic monomers according to U.S. Pat. Nos. 3,264,373 or 3,562,235.

The elastomer B2 is a core-shell polymer obtained by radical polymerization in aqueous phase. It is of the MBS type, that is to say the core is a butadiene/styrene copolymer and the shell is made of PMMA.

B5-B7 were prepared using the process described in the article mentioned in the description.

TABLE 3

| Plasticizer No. | Plasticizer type | Nature |
|---|---|---|
| C1 | Ester | Dibutyl sebacate (DBS) |
| C2 | Sulphonamide | N-n-butylsulphonamide (BBSA) |

TABLE 4

| Composition | % | % | % |
|---|---|---|---|
| No. | fluoropolymer | elastomer | plasticizer |
| α | 95.5 | 2 | 2.5 |
| χ | 93.5 | 4 | 2.5 |
| φ | 90 | 5 | 5 |
| γ | 98 | 2 | 0 |
| η | 96 | 4 | 0 |

The compositions presented above were tested by measuring the tensile strength, the Izod impact strength, the flexural resistance on a sleeved metal tape and the thermal and chemical stability.

The tensile elongation was measured on plaques 0.7 mm thick which were prepared from the extruded compositions described above and moulded at 205° C. using a platen press. Tensile test pieces of the ASTM D 1708 type were cut out from the said plaques using a die cutter. The tensile elongation (elongation at the yield point ε_{y} and the elongation at break ε_{b}) was measured according to the ASTM D 638 standard at room temperature.

The Izod notched impact strength (measured at 23° C. and at −30° C.) was measured on test pieces injection-moulded at 230° C. having the dimensions 80×10×4 mm, the notch and the test protocol being in accordance with the ISO 180-1982 standard.

The flexural resistance on a sleeved metal tape was evaluated at room temperature on a flexible metal structure (interlocked tape having an external diameter of 29 mm) which was sleeved with the illustrated compositions extruded using a crosshead; the sleeve had an average thickness of 4 mm, the extrusion temperature during sleeving being between 200 and 250° C. The tube thus sleeved was placed on two stationary supports 250 mm apart. An 80 mm diameter bending wheel was applied against the tube at an equidistance from the support points, exerting a pressure sufficient to cause the tube to flex until it ruptured. The depth of penetration of the wheel, which is an indication of the deformability of the flexible tube, was measured. The ratio of the penetration depth measured at rupture to a fixed maximum penetration depth of 160 mm corresponds to the flexural resistance on a sleeved metal tape.

The thermal and chemical stability was assessed by measuring the weight change Δw between a 3 mm thick extruded specimen, of mass 5 g, of a given composition and an identical specimen placed for 1 month at 150° C. in a given medium (air or petroleum [containing, by volume, ⅓ cyclohexane, ⅓ isooctane and ⅓ xylene]), the tensile elongation at break (ε_{y} and ε_{b}) of which was also measured. A − (negative number) corresponds to a weight loss.

The chemical stability was assessed by measuring the weight change Δw between a 3 mm thick extruded specimen, of mass 5 g, of a given composition and an identical specimen placed for 7 days at 50° C. in a concentrated (37% by weight) HCl solution, then rinsed in distilled water and oven-dried for 24 h at 150° C. A − sign (negative number) corresponds to a weight loss (Table 5).

The thermal and chemical stability was also assessed by measuring the elongation at break and the Charpy impact strength at 23° C. after ageing for 12 months in air at 150° C. (Table 6).

All the results are given in Tables 5 and 6.

TABLE 5

| | | | | | | | | | Flexural | | | | Stability in | | | |
|---|---|---|---|---|---|---|---|---|---|---|---|---|---|---|---|---|
| | | | | | Tensile | | | | resistance | Stability in air | | | petroleum | | | Stability |
| | | | | | elongation | | Impact strength | | on tape | 1 month at 150° C. | | | 1 month at 150° C. | | | in HCl |
| Composition | | | | | εy | εb | −30° C. | 23° C. | 23° C. | Δw | εy | εb | Δw | εy | εb | Δw |
| No. | Nature | | | % | (%) | (%) | (kJ/m²) | (kJ/m²) | (%) | (%) | (%) | (%) | (%) | (%) | (%) | (%) |
| 1 | A5 | B1 | C1 | φ | 14.8 | 380 | 22 | 98 | 100 | −4.8 | 16 | 280 | 3.3 | >25 | 300 | −6 |
| 2 | A4 | B1 | C1 | α | 13 | 350 | 15 | 68 | 80 | −2.6 | 15.3 | 260 | 1.3 | 22 | 255 | −4 |
| 3 | A5 | B1 | C1 | α | 11.7 | 400 | 24 | 70 | 85 | −2.5 | 13.1 | 350 | 1.3 | 20 | 340 | −4 |
| 4 | A5 | B2 | C1 | α | 12.4 | 420 | 19 | 70 | 75 | −2.3 | 13 | 330 | 2.9 | 20 | 320 | −4 |
| 5 | A7 | B1 | C1 | α | 15 | 350 | 25 | 100 | 80 | −4.7 | 16 | 210 | 3.5 | >25 | 300 | −7 |
| 6 | A4 | B5 | C1 | α | 12.9 | 275 | 15 | 62 | 80 | −2.5 | 11.4 | 250 | 1.2 | 20 | 300 | −3 |
| 7 | A4 | B5 | C1 | χ | 12.7 | 250 | 16 | 72 | 85 | | 12.4 | 230 | | | | |
| 8 | A4 | B6 | C1 | α | 12.7 | 260 | 14 | 60 | 80 | −2.3 | 11.8 | 250 | 1.1 | 18 | 280 | −3 |
| 9 | A4 | B7 | C1 | α | 12.5 | 300 | 18 | 65 | 90 | −2.5 | 12 | 280 | 1.5 | 22 | 300 | −2.5 |
| 10 | A4 | B5 | | γ | 9.4 | 220 | 12 | 48 | 85 | | | | | | | |
| 11 | A5 | B1 | C2 | α | 11.5 | 380 | 22 | 65 | 80 | | | | | | | |
| 12 | A4 | B5 | | η | 9.4 | 270 | 13 | 57 | | | | | | | | |

TABLE 6

| | | | | | Elongation at break ε_{b} (%) | | 23° C. Charpy impact strength | |
|---|---|---|---|---|---|---|---|---|
| | | | | | | After ageing for | | After ageing for |
| Composition | | | | | | 12 months in air at | | 12 months in |
| No. | Nature | | | % | Before ageing | 150° C. | Before ageing | air at 150° |
| 2 | A4 | B1 | C1 | α | 350 | 180 | 68 | 15 |
| 11 | A5 | B1 | C2 | α | 380 | 160 | 65 | 15 |
| 3 | AS | B1 | C1 | α | 400 | 180 | 70 | 12 |
| 6 | A4 | B5 | C1 | α | 275 | 280 | 62 | 65 |
| 10 | A4 | B5 | | γ | 220 | 180 | 48 | 78 |
| 12 | A4 | B5 | | η | 270 | 210 | 56 | 85 |
| 8 | A4 | B6 | C1 | α | 260 | 260 | 60 | 65 |
| 9 | A4 | B7 | C1 | α | 300 | 290 | 65 | 70 |
| 7 | A4 | B5 | C1 | χ | 250 | 250 | 72 | 81 |

The preceding examples can be repeated with similar success by substituting the generically or specifically described reactants and/or operating conditions of this invention for those used in the preceding examples.

The entire disclosure of all applications, patents and publications, cited herein and of corresponding French application No. 02.02876, filed Mar. 7, 2002, is incorporated by reference herein.

From the foregoing description, one skilled in the art can easily ascertain the essential characteristics of this invention and, without departing from the spirit and scope thereof, can make various changes and modifications of the invention to adapt it to various usages and conditions.

1. Flexible and tough composition comprising:
at least one vinylidene fluoride (VF2) homopolymer (A) or a copolymer (A) of VF2 and at least one other monomer copolymerizable with VF2, in which the said monomer is present in an amount of between 0 and 30 parts by weight per 100 parts by weight of VF2,
at least one fluoroelastomer B,
optionally a plasticizer C,
in which, on the one hand, the said composition comprises from 0.5 to 10 parts by weight of B and from 0 to 10 parts by weight of C per 100 parts by weight of A, with the additional condition that the sum of B and C is from 0.5 to 10.5 parts by weight and, on the other hand, the vinylidene fluoride homopolymer or copolymer (A) is chosen in such a way that it has a melt flow index, measured according to the ISO 1133 standard at 230° C. under a load of 5 kg, of less than 5 g/10 min and a critical modulus G_{C}, at the intersection of the melt shear moduli G′ and G″ measured at 190° C., of between 5 and 22 kPa.

2. Composition according to claim 1, in which the said other monomer in A is present in an amount of between 0 and 5 parts by weight.

3. Composition according to claim 1 or 2, in which the said other monomer in A is a fluoromonomer.

4. Composition according to one of claims 1 to 3, in which B is present in a relative amount of 0.5 to 5 parts by weight.

5. Composition according to one of claims 1 to 4, in which C is present in a relative amount of 0.5 to 5 parts by weight.

6. Composition according to any one of the preceding claims, in which the elastomer B is chosen from VF2/HFP copolymers in which the proportions by weight of VF2 are between 50 and 75% for 50 to 25% HFP respectively.

7. Composition according to any one of claims 1 to 5, in which the elastomer B is chosen from VF2/HFP/TFE copolymers containing 45 to 65% VF2, the proportions of HFP and TFE being such that the HFP/TFE weight ratio is between 1/5 and 5/1 and preferably 1/2 and 2/1.
